(19) United States
(12) Patent Application Publication
(10) Pub. No.: US 2012/0225337 A1
(43) Pub. Date: Sep. 6, 2012

(54) NON-AQUEOUS ELECTROLYTE SECONDARY BATTERY AND METHOD OF PRODUCING THE SAME

(76) Inventors: Yasushi Nakagiri, Tokushima (JP); Hiroaki Furuta, Osaka (JP); Yasuhiko Hina, Tokushima (JP); Yuji Yokoyama, Osaka (JP); Shinpei Yamagami, Tokushima (JP); Akira Nagasaki, Osaka (JP); Norihiro Yamamoto, Osaka (JP)

(21) Appl. No.: 13/510,816

(22) PCT Filed: Aug. 8, 2011
(86) PCT No.: PCT/JP2011/004496

§ 371 Date: May 18, 2012

(30) Foreign Application Priority Data
Sep. 21, 2010 (JP) 2010-210390

(51) Int. Cl. H01M 4/00; H01M 4/139

(52) U.S. Cl. 429/94; 29/623.3

(57) ABSTRACT

A non-aqueous electrolyte secondary battery comprising: an electrode group in which a long first electrode, a long second electrode, and a long separator disposed therebetween are wound spirally; and a non-aqueous electrolyte, is provided. The first electrode includes a sheet-like first current collector and a first active material layer disposed on a surface of the first current collector. The second electrode includes a sheet-like second current collector and a second active material layer disposed on a surface of the second current collector. An end portion of the first electrode on a winding-end side of the electrode group has a non-linear form and faces the second electrode placed on an outer circumferential side with the separator therebetween. The non-linear form is preferably a periodically continuous form, for example a waveform.

### TECHNICAL FIELD

The present invention relates to a non-aqueous electrolyte secondary battery comprising: an electrode group in which a long first electrode, a long second electrode, and a long separator disposed therebetween are wound spirally; and a non-aqueous electrolyte. In particular, the present invention relates to a form of an end portion on a winding-end side of one electrode and a positional relation between the above electrode and the other electrode.

### BACKGROUND ART

In recent years, portable and cordless electronic devices have been developed rapidly. As power sources for driving such devices, small and lightweight secondary batteries for small-sized consumer products having a high energy density are used. Also, as power sources for driving energy storage equipment and electric vehicles, large-sized secondary batteries have been developed. For these secondary batteries, characteristics such as high output performance, durability for a long period of time, and safety are demanded. Therefore, non-aqueous electrolyte secondary batteries having a high voltage and a high energy density have been developed actively.

In non-aqueous electrolyte secondary batteries represented by lithium ion secondary batteries, for example, a positive electrode and a negative electrode, each in which an active material layer is formed on a surface of a sheet-like current collector, are used. By winding spirally the positive electrode and the negative electrode with a separator disposed therebetween, an electrode group is formed. The electrode group is housed in a battery case together with a non-aqueous electrolyte. With respect to such wound-type non-aqueous electrolyte secondary batteries, attempts have been made for them to have a higher energy density, by compressing the active material layer to achieve a higher density, or by making thinner the metal foils to be used as current collectors. Under such circumstances, there arise problems of rupture and the like of electrodes caused by tension applied when the active material layer is compressed or when the electrodes are wound.

In view of above, Patent Literature 1 defines a ratio of: an active material filling density of a portion where an active material layer is formed on only one surface of the current collector; and an active material filling density of a portion where the active material layer is formed on both surfaces of the current collector. This intends to suppress separation of the active material layer formed on only one surface of the current collector and also to prevent rupture of electrodes caused by an excessive pressure applied to the portion where the active material layer is formed on both surfaces of the current collector during production process of the electrodes.

Meanwhile, Patent Literature 2 proposes to make the form of the electrode group close to a frusto-conical form, in view of facilitating injection of the electrolyte and discharge of produced gas by forming a gap in a battery case that houses the electrode group. Specifically, Patent Literature 2 proposes to make an end portion on a winding-end side of at least one of the positive electrode and the negative electrode, oblique, with respect to the widthwise direction of the electrode.

### CITATION LIST

### Patent Literature

[PTL 1] Japanese Laid-Open Patent Publication 2009-252349
[PTL 2] Japanese Laid-Open Patent Publication 2004-296159

### SUMMARY OF INVENTION

### Technical Problem

Patent Literature 1 enables to avoid rupture of electrodes during the production process of electrodes. However, rupture of electrodes may also occur in a completed battery. For example, when rapid charge and discharge of the battery are performed in a high-temperature environment, rupture may be caused on an electrode in the vicinity of the outermost circumference of the electrode group, thereby increasing the internal resistance and decreasing the capacity. If the rupture advances to cut the electrode completely, there will be no conduction and the capacity will be lost.

In lithium ion secondary batteries, lithium ions move between the positive electrode and the negative electrode by charge and discharge. Generally, an electrode absorbing lithium ions swells and an electrode releasing lithium ions shrinks. Therefore, it is known that the magnitude and the direction of tension applied to the electrodes during the production process of the electrodes change by charge and discharge cycle.

As a result of studies by the present inventors, it was found that, in the vicinity of the outermost circumference of the electrode group, an end portion of the other electrode is often positioned on an inner side of the portion where rupture of an electrode is caused. Consequently, the rupture of one electrode is considered to result from a step-like form created at the end portion on the winding-end side of the other electrode. The end portion on the winding-end side of the electrode applies tension to the electrode on the outer circumferential side that faces the end portion. Further, the magnitude and the direction of the tension changes continuously by the charge and discharge cycle. These are assumed to cause rupture of the electrode due to metal fatigue of the current collector. Since the change of the tension by the charge and discharge cycle becomes greater when rapid charge and discharge are performed in a high-temperature environment, the above problem is considered to become notable.

If the thickness of the active material layer is decreased in the end portion of the electrode on the inner circumferential side that has the step-like form, the tension applied to the electrode on the outer circumferential side that faces the end portion can be reduced. However, since the active material layer having a decreased thickness tends to separate from the current collector, the productivity of the battery lowers. Also, when a separated object enters between the electrodes, defects due to internal short circuit may occur.

As in Patent Literature 2, when the end portion of the electrode on the inner circumferential side is made oblique, the tension applied to the electrode on the outer circumferential side that faces the end portion can be reduced to some extent, by increasing the angle of the end portion with respect to the widthwise direction of the electrode. However, the electrode having such an end portion makes handling of the end portion difficult, and manufacture defects are likely to occur. In contrast, when the angle of the end portion with respect to the widthwise direction of the electrode is small, the tension applied to the electrode on the outer circumferential side is hardly reduced.

### Solution To Problem

The present invention has an object to provide a non-aqueous electrolyte secondary battery that can suppress rupture of electrodes even when rapid charge and discharge are performed in a high-temperature environment, without lowering productivity.

That is, the present invention relates to a non-aqueous electrolyte secondary battery comprising: an electrode group in which a long first electrode, a long second electrode, and a long separator disposed therebetween are wound spirally; and a non-aqueous electrolyte,

wherein the first electrode includes a sheet-like first current collector and a first active material layer disposed on a surface of the first current collector,

the second electrode includes a sheet-like second current collector and a second active material layer disposed on a surface of the second current collector, and

an end portion of the first electrode on a winding-end side of the electrode group has a non-linear form and faces the second electrode with the separator therebetween, the second electrode being placed on an outer circumferential side that is further outward than the end portion.

More specifically, the aforementioned non-aqueous electrolyte secondary battery comprises: an electrode group in which a positive electrode, a negative electrode, and a separator disposed therebetween are wound; and a non-aqueous electrolyte. The positive electrode includes a sheet-like positive electrode current collector and a positive electrode active material layer disposed on a surface of the positive electrode current collector. The negative electrode includes a sheet-like negative electrode current collector and a negative electrode active material layer disposed on a surface of the negative electrode current collector. In the electrode group, an end portion on an outer circumferential side of one electrode selected from the positive electrode and the negative electrode faces the other electrode positioned on an outer circumferential side that is further outward, and the end portion has a non-linear form.

By having such a structure, the tension applied by the end portion of the electrode due to its step-like form, to the electrode positioned on an outer circumferential side, can be dispersed. Therefore, the change of the tension can be eased and rupture of electrodes can be suppressed even when rapid charge and discharge are performed in a high-temperature environment.

Also, the present invention relates to a method of producing a non-aqueous electrolyte secondary battery comprising the steps of:

preparing a first electrode continuum in which a plurality of long first electrodes ranges in a lengthwise direction;

cutting out one of the long first electrode from the first electrode continuum, the one first electrode having one end portion in the lengthwise direction thereof in non-linear form;

preparing a long second electrode;

preparing a long separator; and

winding spirally the one first electrode, the second electrode, and the separator disposed therebetween, such that the end portion in non-linear form of the first electrode is an end portion on a winding-end side and that the second electrode is placed on an outer circumferential side being further outward than the end portion and faces the end portion with the separator therebetween.

That is, the method of producing a non-aqueous electrolyte secondary battery in accordance with the present invention comprises a positive electrode cutting step, a negative electrode cutting step, and an electrode group production step for disposing the separator between the positive electrode and the negative electrode obtained by the cutting and and then winding the resultant spirally. In the positive electrode cutting step, a positive electrode corresponding to one electrode group is cut out from a positive electrode continuum (also referred to as a positive electrode hoop) in which a plurality of long positive electrodes ranges in the lengthwise direction thereof. In the negative electrode cutting step, a negative electrode corresponding to one electrode group is cut out from a negative electrode continuum (also referred to as a negative electrode hoop) in which a plurality of long negative electrodes ranges in the lengthwise direction thereof. The positive electrode is produced by forming a positive electrode active material layer on a surface of a long sheet-like positive electrode current collector. The negative electrode is produced by forming a negative electrode active material layer on a surface of a long negative electrode current collector. The positive electrode cutting step or the negative electrode cutting step is a step for cutting so as to produce an end portion in non-linear form on the electrode. In the electrode group production step, the positive electrode, the negative electrode, and the separator are wound, such that an end portion in non-linear form of one electrode is an end portion on the winding-end side of the electrode group and that the other electrode is positioned on an outer circumferential side being further outward than the end portion in non-linear form.

Further, another method of producing a non-aqueous electrolyte secondary battery in accordance with the present invention comprises the steps of:

providing a first electrode continuum in which a plurality of long first electrodes ranges in a lengthwise direction;

providing a second electrode continuum in which a plurality of long second electrodes ranges in a lengthwise direction;

providing a separator continuum having a length of a plurality of long separators;

winding spirally the first electrode continuum, the second electrode continuum, and the separator continuum disposed therebetween, from a winding-start position to a winding-end portion, that are respectively corresponding to an n^{th} first electrode, an n^{th} second electrode, and an n^{th} separator;

cutting the first electrode continuum at the winding-end position of the n^{th} first electrode, such that an end portion in non-linear form is produced on the n^{th} first electrode and an (n+1)^{th} first electrode; and

cutting each of the separator continuum and the second electrode continuum at the winding-end position, such that the n^{th} second electrode is placed on an outer circumferential side being further outward than the end portion in non-linear form and that the n^{th} second electrode faces the end portion in non-linear form with the n^{th} separator therebetween.

That is, the other method of producing a non-aqueous electrolyte secondary battery in accordance with the present invention comprises: an electrode group production step for winding spirally the positive electrode which is a part of the positive electrode continuum and the negative electrode which is a part of the negative electrode continuum, with a part of the separator continuum disposed therebetween; a positive electrode cutting step for cutting the positive electrode continuum; and a negative electrode cutting step for cutting the negative electrode continuum. The positive electrode cutting step or the negative electrode cutting step is a step for cutting so as to produce an end portion in non-linear form on the electrode, the end portion in non-linear form being an end portion on the winding-end side of the electrode group. The cutting step of the other electrode is performed after the other electrode is wound to an outer circumferential side that is further outward, so as to cover the end portion.

The above production method may further comprise the steps of:

cutting out the (n+1)^{th} first electrode from the first electrode continuum, such that an end portion in linear form is produced on the (n+1)^{th} first electrode and an (n+2)^{th} first electrode;

winding spirally the (n+1)^{th} first electrode and the second electrode continuum from a winding-start position to a winding-end position corresponding to the (n+1)^{th} second electrode, with the separator continuum from a winding-start position to a winding-end position corresponding to an (n+1)^{th} separator therebetween, such that the end portion in non-linear form of the (n+1)^{th} first electrode is an end portion on the winding-end side; and

cutting each of the separator continuum and the second electrode continuum at the winding-end position, such that the (n+1)^{th} second electrode is placed on an outer circumferential side being further outward than the end portion in non-linear form and that the (n+1)^{th} second electrode faces the end portion in non-linear form with the (n+1)^{th} separator therebetween.

When the above non-linear form is a point-symmetric form with respect to a center thereof, it is possible to prevent the direction of the non-linear form in the battery from being different among batteries by changing appropriately the direction of the (n+1)^{th} first electrode that has been cut out.

### Advantageous Effects of Invention

According to the present invention, rupture of electrodes in the vicinity of the outermost circumference of the electrode group can be suppressed even when the battery is rapidly charged and discharged in a high-temperature environment. Therefore, non-aqueous electrolyte secondary batteries exhibiting excellent cycle characteristics can be provided without lowering productivity.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

[FIG. 1]

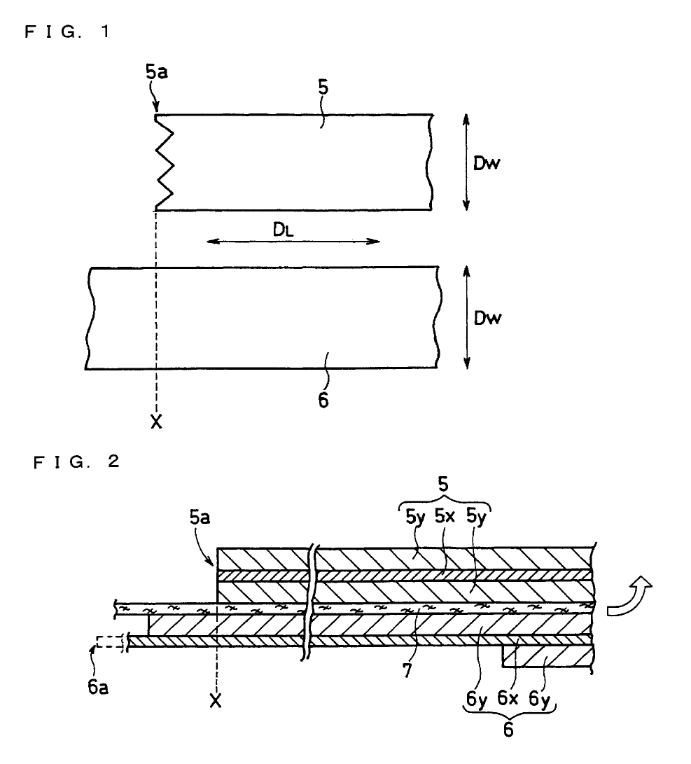

A view showing conceptually a positional relation between the first electrode and the second electrode in the vicinity of the winding-end side of the electrode group.

[FIG. 2]

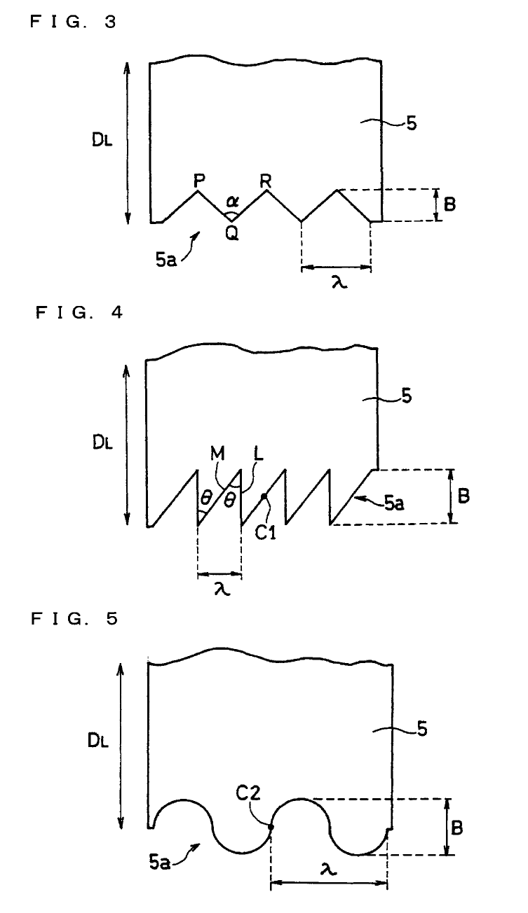

A sectional view showing an example of a positional relation between the first electrode and the second electrode in the vicinity of the winding-end side of the electrode group.

[FIG. 3]

A view showing an example of the end portion of the first electrode in which the non-linear form is a triangle wave or a zigzag form.

[FIG. 4]

A view showing an example of the end portion of the first electrode in which the non-linear form is a saw tooth wave form.

[FIG. 5]

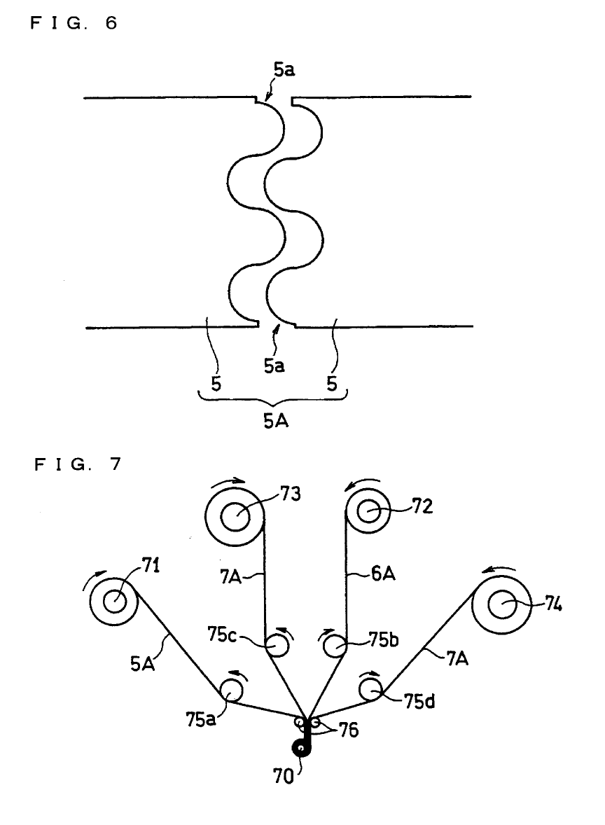

A view showing an example of the end portion of the first electrode in which the non-linear form is that of arcs in a continuous pattern, the arcs connected at both ends such that the arcs are alternately in opposite directions.

[FIG. 6]

A view showing a manner in which two end portions in non-linear form are produced by cutting the first electrode continuum at one position to create the non-linear form.

[FIG. 7]

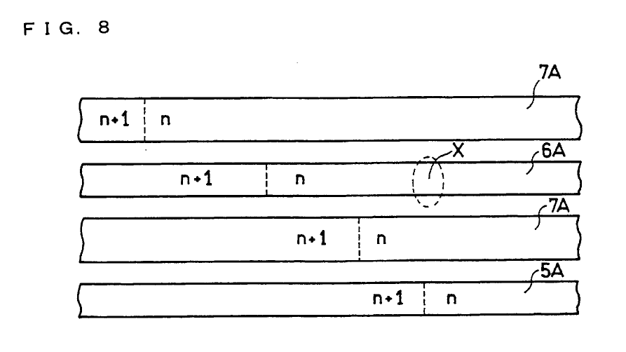

A view showing a continuous production process of the electrode group.

[FIG. 8]

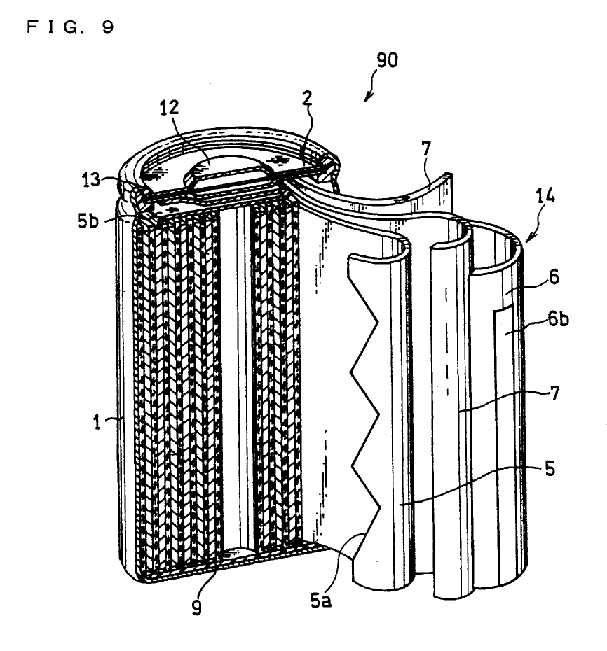

A view showing schematically a relation of cutting positions of the respective continuums in the production process.

[FIG. 9]

An oblique view of a cylindrical lithium ion secondary battery in accordance with an embodiment of the present invention from which a part thereof is cut away and a part thereof is exploded.

### DESCRIPTION OF EMBODIMENTS

The non-aqueous electrolyte secondary battery in accordance with the present invention comprises: an electrode group in which a long first electrode, a long second electrode, and a long separator disposed therebetween are wound spirally; and a non-aqueous electrolyte. Two separators are used for one electrode group. Specifically, the electrode group is produced by disposing the first electrode or the second electrode between a pair of separators, placing the other electrode on outside of one of the separators, and winding spirally four sheet members in total. The electrode group has a cylindrical form having a circular cross section, a form of an oblong cylinder having an oval cross section, or the like.

As shown in FIG. 1, a first electrode 5 has a form of a long strip having a pair of long sides along a lengthwise direction (DL) and a pair of short sides along a widthwise direction (DW). Herein, one of the short sides has not a linear form but has a non-linear form. An end portion 5a corresponding to the short side having such a non-linear form is placed on a winding-end side of the electrode group. That is, the end portion 5a placed on the outermost circumference of the first electrode 5 has the non-linear form.

As shown in FIG. 1, a second electrode 6 also has a form of a long strip having a pair of long sides along the lengthwise direction (DL) and a pair of short sides along the widthwise direction (DW). Neither side along the widthwise direction of the second electrode 6 should necessarily have a non-linear form.

FIG. 2 is a sectional view of a main part in the vicinity of the outmost circumference of the electrode group that is wound spirally. The upper side of FIG. 2 is an inner circumferential side and the lower side thereof is an outer circumferential side of the electrode group. An end portion 6a placed on the outermost circumference of the second electrode 6 passes the end portion 5a in non-linear form of the first electrode 5 at least once from the outer circumferential side. That is, the second electrode 6 is placed on an outer circumferential side being further outward than the end portion 5a in non-linear form of the first electrode 5. Also, the end portion 5a in non-linear form of the first electrode 5 faces the second electrode 6 on an outer circumferential side with a separator 7 therebetween.

The end portion 5a of the first electrode 5 applies tension to a portion shown by a broken line X of the second electrode 6 on the outer circumferential side that faces the end portion 5a. Also, the magnitude and the direction of the tension changes continuously by charge and discharge cycle. In particular, when rapid charge and discharge are performed in a high-temperature environment, the change of tension by the charge and discharge cycle tends to be greater. However, since the end portion 5a of the first electrode 5 has the non-linear form, such tension is eased greatly. The reason for this is that, by making the end portion 5a into the non-linear form, stress applied to the second electrode 6 on the outer circumferential side is dispersed and a linear stress is not applied. Therefore, a linear rupture is hardly caused in the second electrode 6.

The first electrode 5 includes a sheet-like first current collector 5x and a first active material layer 5y disposed on a surface of the first current collector 5x, and the second electrode 6 includes a sheet-like second current collector 6x and a second active material layer 6y disposed on a surface of the second current collector 6x. Each active material layer may be a material mixture layer including an active material as an essential component and including a binder etc. as an optional component, or may be a deposited film formed by depositing an active material on a surface of the current collector. The deposited film may be a film formed in a vacuum or an environment under reduced pressure by vapor deposition or sputtering, or a film formed in a thermal plasma environment.

The current collector is a sheet-like conductive material having a pair of main surfaces, and the active material layer is formed on one or both surfaces of the current collector. When the active material layer is formed on both surfaces of the current collector, an exposed portion of the current collector not carrying the active material is formed partly on the electrode for various reasons. For example, as in the second electrode 6 in FIG. 2, an area where both surfaces of the current collector are exposed, which has no active material layer on both surfaces, or an area where one surface of the current collector is exposed, which has an active material layer on only one surface, may be formed in an area within a predetermined length from the end portion 6a. Such an exposed portion can be used for connection of leads.

Next, the non-linear form will be explained.

The non-linear form may be any form other than the linear form, and preferably includes polygonal lines in a continuous pattern (a series of polylines), curves in a continuous pattern (a series of curves), or a waveform. In particular, when the same form continues as a zigzag form or a waveform, it is possible to prevent effectively local application of stress on the second electrode on the outer circumferential side. Also, the stress applied to the second electrode on the outer circumferential side can be dispersed evenly.

However, the polygonal lines in a continuous pattern or the curves in a continuous pattern may partly include segments of different polygonal lines or different curves. Also, all the segments of polygonal lines or curves may be different from each other. Segments of polygonal lines and curves may be mixed.

It is preferable that the portion in non-linear form is produced on the end portion for ⅔ (66%) or more of the length in the widthwise direction of the first electrode. The remaining part may be a straight line parallel to the widthwise direction DW of the first electrode. Further, it is most preferable that the entire end portion of the first electrode has the non-linear form.

When the non-linear form is a waveform, the type of the waveform is not particularly limited. Examples thereof include a triangle wave, a saw tooth wave, a sine wave, a trapezoidal wave, a square wave, or arcs in a continuous pattern, the arcs being connected at both ends such that they are alternately in opposite directions. The non-linear form may be a form close to these waveforms.

FIG. 3 shows an example of the non-linear form having a triangle wave or a zigzag form. The form made by connecting three consecutive turning points P, Q, and R may be a regular triangle or an isosceles triangle. By having such a form, it is easy to prevent application of a linear stress that is parallel to the rupture direction to the second electrode on the outer circumferential side over the entire end portion of the first electrode. An angle α formed by a line segment PQ and a line segment QR is preferably 45 to 135° in view of preventing separation of the active material from tip portions caused by forming a too acute angle and local concentration of stress.

FIG. 4 shows an example of the non-linear form having a saw tooth wave form. The saw tooth wave form is formed by a linear portion L parallel to the lengthwise direction (DL) of the electrode and an oblique line portion M that intersects the linear portion L with an angle θ. By having such a form, the stress applied to the second electrode by the linear portion L is made perpendicular to the rupture direction. Therefore, the effect of preventing the rupture of the second electrode can be improved further. From the same viewpoint as above, the angle θ is preferably 45 to 67.5°.

It is preferable that the tips (corresponding to point Q) of the triangle wave or the tips (tooth edges) of the saw tooth wave are made round in an arc form, for example. In the same manner, it is preferable that corner portions of the trapezoidal wave or the square wave are made round. By eliminating sharp protrusions from the non-linear form, the tension can be dispersed more easily, thereby preventing more effectively the rupture of the second electrode on the outer circumferential side. It is preferable that at least acute angle portions are eliminated from the non-linear form.

The non-linear form is preferably a point-symmetric form with respect to a center thereof. Such a form is advantageous in the continuous production of the first electrode. An electrode is usually produced by cutting, at both ends of each electrode, a first electrode continuum in which a plurality of long first electrodes ranges in the lengthwise direction thereof. Two end portions in non-linear form are produced by cutting at one position to create the non-linear form. At this time, if the non-linear form is a point-symmetric form, two electrodes having an end portion in non-linear form and having an equivalent form can be produced. Also, in the production of the first electrode, reduction in resource loss can be facilitated. It is to be noted that the form of the saw tooth wave in FIG. 4 is a non-linear form that is point-symmetric with respect to a center C1.

FIG. 5 shows an example of arcs in a continuous pattern, the arcs being connected at both ends such that they are alternately in opposite directions. Also, FIG. 6 shows a manner in which two end portions in non-linear form are produced by cutting a first electrode continuum 5A at one position to create the non-linear form. Such a form is a point-symmetric form with respect to a center C2 and does not have sharp protrusions. Therefore, such a form is advantageous in the continuous production of the first electrode and has a high effect of preventing the rupture of the second electrode on the outer circumferential side. The non-linear form of a sine wave is also preferable from the same viewpoint.

If the non-linear form is the waveform, the wave height (twice the amplitude) is preferably 3 to 15 mm, more preferably 5 to 10 mm. By having such a wave height, the stress applied to the second electrode on the outer circumferential side can be dispersed sufficiently, while handling of the end portion of the first electrode is not difficult. For the same reason, the wave length is preferably 3 to 45 mm, more preferably 5 to 30 mm. In FIGS. 3 to 5, the wave height is indicated by B, and the wave length is indicated by λ.

Next, a method of producing a non-aqueous electrolyte secondary battery in accordance with the present invention will be described.

First, a first electrode continuum in which a plurality of long first electrode ranges in the lengthwise direction thereof is prepared. Such a continuum is produced by forming a first active material layer in a predetermined pattern on a surface of a first current collector material having a length of the plurality of the first electrodes. Next, one of the long first electrodes having one end portion in the lengthwise direction thereof in non-linear form is cut out from the first electrode continuum. That is, the one first electrode corresponding to one electrode group is cut out from the first electrode continuum. At this time, the cutting is performed at a predetermined cutting position to create the non-linear form.

Both end portions in the lengthwise direction of the first electrode continuum before being used for the production of the electrode group has generally a linear form. Therefore, when the first one of the first electrodes is cut out from the continuum, the cutting is performed at a first cutting position to create the non-linear form. Next, cutting is performed at a second cutting position to create the linear form. Subsequently, the cutting into the non-linear form and the cutting into the linear form are repeated alternately. By such operations, a first electrode having one end portion in the lengthwise direction thereof in non-linear form and the other end portion in linear form can be produced.

Meanwhile, a long second electrode and a long separator are prepared respectively. Preparation of the second electrode can be performed by any method. However, in the same manner as the first electrode, it is effective to prepare a second electrode continuum in which a plurality of long second electrodes ranges in the lengthwise direction thereof and to then cut out one of the second electrodes corresponding to one electrode group from the continuum.

The electrode group is formed by winding spirally a long first electrode, a long second electrode, and long separators, by using winding cores. More specifically, the first electrode, the separator, the second electrode, and the other separator are stacked in this order in the state where the end portions of the two separators protrude in the lengthwise direction thereof. By winding spirally the stacked first electrode, second electrode, and separators in the state where the protruded end portions of the separators are sandwiched between a pair of winding cores, the electrode group in spiral form is produced.

At the time of the winding, the end portion in non-linear form of the first electrode is an end portion on the winding-end side. Then, the second electrode is placed on an outer circumferential side that is further outward than the end portion of the first electrode, and the end portion of the first electrode is made to face the second electrode with the separator therebetween. Thereafter, an end portion of the member on the outermost circumference of the electrode group is fixed with an insulating tape or the like.

In a more effective and continuous production process, a first electrode continuum in which a plurality of long first electrodes ranges in the lengthwise direction thereof, a second electrode continuum in which a plurality of long second electrodes ranges in the lengthwise direction thereof, and separator continuums having a length of a plurality of long separators, are used. Then, the first electrode, the second electrode, and the separators corresponding respectively to one electrode group are rolled out from one end portion of each continuum, and rolled up by the winding core.

FIG. 7 is a view illustrating an example of the continuous production process as described above.

A first electrode continuum 5A is rolled out from a first electrode rolling-out roller 71. A second electrode continuum 6A is rolled out from a second electrode rolling-out roller 72. A pair of separator continuums 7A is rolled out from separator continuum rolling-out rollers 73 and 74. Each rolled-out continuum runs on each surface of tension rollers 75a, 75b, 75c, and 75d, thereby applying an appropriate tension to each continuum. In this state, the first electrode continuum 5A, the separator continuum 7A, the second electrode continuum 6A, and the other separator continuum 7A are stacked in this order by a pair of control rollers 76 and are rolled up by a winding core 70.

After an n^{th} first electrode, an n^{th} second electrode, and n^{th} separators are rolled out from the respective continuums and wound, the first electrode continuum 5A is cut at the winding-end position of the n^{th} first electrode. At this time, the cutting is performed such that an end portion in non-linear form is produced on each of the n^{th} first electrode and the (n+1)^{th} first electrode. Next, the n^{th} second electrode is placed on an outer circumferential side that is further outward than the end portion in non-linear form, such that the n^{th} second electrode faces the end portion in non-linear form of the first electrode with the n^{th} separator therebetween. Subsequently, the second electrode continuum 6A and the separator continuum 7A are cut at the respective winding-end positions of the n^{th} separator and the n^{th} second electrode. The cutting at the respective winding-end positions of the separator continuum and the second electrode continuum may be performed before the second electrode is placed so as to face the end portion in non-linear form of the first electrode.

FIG. 8 shows schematically an example of a relation of cutting positions of the respective continuums.

Each continuum is cut out sequentially from the right-hand side of FIG. 8. In the method as described above, when the n^{th} first electrode is cut out from the first electrode continuum 5A, an end portion in non-linear form is produced on each of the n^{th} first electrode and the (n+1)^{th} first electrode. That is, it is desirable that the end portion formed when the n^{th} first electrode is cut out is the end portion on the winding-end side of the next electrode group. Meanwhile, it is effective as a production process that the end portions of the second electrode continuum 6A and the separator continuum 7A produced when the n^{th} second electrode and the n^{th} separator are cut out respectively, are both the end portions on the winding-start side of the next electrode group.

Therefore, in order for the end portion in non-linear form of the (n+1)^{th} first electrode to become the end portion on the winding-end side, the (n+1)^{th} first electrode may be cut out beforehand from the first electrode continuum 5A. That is, a step of cutting out the (n+1)^{th} first electrode from the first electrode continuum may be performed, such that an end portion in linear form is produced in each of the (n+1)^{th} first electrode and the (n+2)^{th} first electrode. Then, the (n+1)^{th} first electrode and the second electrode continuum from the winding-start position to the winding-end position corresponding to the (n+1)^{th} second electrode are wound, with the separator continuum from the winding-start position to the winding-end position corresponding to the (n+1)^{th} separator therebetween, such that the end portion in linear form is the end portion on the winding-start side and the end portion in non-linear form is the end portion on the winding-end side.

Next, the (n+1)^{th} second electrode is placed on an outer circumferential side that is further outward than the end portion in non-linear form of the (n+1)^{th} first electrode, and the (n+1)^{th} second electrode is made to face the end portion in non-linear form with the (n+1)^{th} separator therebetween. Subsequently, each of the separator continuum and the second electrode continuum is cut at the winding-end position. Herein, the cutting at the winding-end position of each of the separator continuum and the second electrode continuum may be performed before the second electrode is placed so as to face the end portion in non-linear form of the first electrode.

The end portion in non-linear form produced when the n^{th} first electrode is cut out may not necessarily be the end portion on the winding-end side of the (n+1)^{th} first electrode. For example, the end portion in non-linear form may be cut off in a very small width from the first electrode continuum 5A. An end portion in linear form is produced by such cutting and this may be the end portion on the winding-start side of the (n+1)^{th} first electrode.

Next, a structure of a cylindrical lithium ion secondary battery will be described as an example of the non-aqueous electrolyte secondary battery of the present invention.

FIG. 9 is an oblique view of a cylindrical lithium ion secondary battery from which a part thereof is cut away and a part thereof is exploded. A lithium ion secondary battery 90 includes an electrode group 14 in which a long or strip-like positive electrode 5 and a long or strip-like negative electrode 6 are wound with a separator 7 disposed therebetween. The electrode group 14 is housed in a metal battery case 1 of cylindrical type with a bottom, together with a non-aqueous electrolyte (not illustrated). The positive electrode 5 includes a sheet-like positive electrode current collector and a positive electrode active material layer adhered to a surface thereof. The negative electrode 6 includes a sheet-like negative electrode current collector and a negative electrode active material layer adhered to a surface thereof. Herein, an end portion 5a on the winding-end side of the positive electrode 5 has a triangle wave form or a zigzag form.

In the electrode group 14, a positive lead terminal 5b is electrically connected with the positive electrode 5 and a negative lead terminal 6b is electrically connected with the negative electrode 6. The electrode group 14 is housed in a battery case 1 together with a lower insulating plate 9 in the state where the positive lead terminal 5b is led out. A sealing plate 2 is welded to an end portion of the positive lead terminal 5b. The sealing plate 2 includes a positive external terminal 12 and a safety mechanism of a PTC device and an explosion-proof valve (not illustrated).

The lower insulating plate 9 is sandwiched between a bottom surface of the electrode group 14 and the negative lead terminal 6b led out to the lower side from the electrode group 14, and the negative lead terminal 6b is welded to an inner bottom surface of the battery case 1. An upper insulating ring (not illustrated) is mounted on an upper surface of the electrode group 14, and an annular step portion is formed on an upper side surface of the battery case 1 over the upper insulating ring. Thus, the electrode group 14 is fixed in the battery case 1. Next, a predetermined amount of the non-aqueous electrolyte is injected into the battery case 1, and the positive lead terminal 5b is bent and housed in the battery case 1. The sealing plate 2 provided with a gasket 13 on the periphery thereof is mounted on the step portion. Then, an opening end portion of the battery case 1 is calked inward and sealed, thereby completing a cylindrical lithium ion secondary battery.

The electrode group 14 is produced by stacking the positive electrode 5, the separator 7, the negative electrode 6, and the other separator 7 in this order and winding the same by using winding cores (not illustrated), and then removing the winding cores. For a few rounds from the start of the winding (first to third round of winding, for example), the electrode group 14 may be in the state where only the two separators 7 are wound.

The structure as above is particularly advantageous in producing an electrode group with a high capacity by using a positive electrode or a negative electrode in which a large amount of active material is filled and winding the same with a high tension. A battery with a high capacity has a capacity density (value obtained by dividing nominal capacity of battery by mass of battery) of, for example, 44,000 mAh/kg or more, further, 51,000 mAh/kg or more. It is to be noted that the upper limit of the capacity density is about 75,000 mAh/kg. For example, a 18,650-type cylindrical battery with a high capacity has a nominal capacity of 2,000 mAh or more, preferably 2,300 mAh or more. Therefore, the 18,650-type battery is appropriate for the above winding structure.

When the positive electrode and the negative electrode in which a large amount of active material is filled are wound with the separator disposed therebetween, the outer diameter of the electrode group tends to increase. In this case, in order to house the electrode group in a case with a certain volume, it is necessary to apply a high tension to the separator sandwiched by the winding cores and wind the same with the electrodes. By winding with a high tension, adhesion of the positive electrode and the negative electrode with the separator is strengthened. Therefore, there is improvement in the effect of making the end portion of one electrode into the non-linear form and thus dispersing the stress that is on the other electrode placed on the outer circumference side.

Although the cylindrical electrode group is described in FIG. 9, the form of the electrode group is not limited thereto. For example, the electrode group may be of a flat form having an oval end surface perpendicular to the winding axis, which is used in prismatic batteries.

The respective constituents of the present invention will be described in more detail.

### Positive Electrode

The positive electrode includes a sheet-like positive electrode current collector and a positive electrode active material layer adhered to a surface of the positive electrode current collector. As the positive electrode current collector, a known positive electrode current collector for use in non-aqueous electrolyte secondary batteries, for example, metal foil made of aluminum, an aluminum alloy, stainless steel, titanium, a titanium alloy etc. can be used. The material of the positive electrode current collector can be selected suitably by considering processability, practical strength, adhesiveness to the positive electrode active material layer, electronic conductivity, corrosion resistance, etc. The thickness of the positive electrode current collector is, for example, 1 to 100 μm, preferably 10 to 50 μm.

The positive electrode active material layer may include a conductive agent, a binder, a thickener, etc. in addition to the positive electrode active material. As the positive electrode active material, for example, a lithium-containing transition metal compound accepting lithium ions as a guest can be used. Examples thereof include: composite metal oxides of at least one metal selected from cobalt, manganese, nickel, chromium, iron, and vanadium, and lithium; LiCoO₂; LiMn₂O₄; LiNiO₂; LiCoₓNi(₁₋ₓ₎O₂ (0<x<1); LiCo_{y}M_{1-y}O₂ (0.6≦y<1); LiNi_{z}M_{1-z}O₂ (0.6≦z<1); LiCrO₂; αLiFeO₂; and LiVO₂. In the above composition formulae, M represents at least one element selected from the group consisting of Na, Mg, Sc, Y, Mn, Fe, Co, Ni, Cu, Zn, Al, Cr, Pb, Sb, and B (in particular, Mg and/or Al). The positive electrode active material may be used singly or in combination of two or more.

The binder is not particularly limited as long as it can be dissolved or dispersed in a dispersing medium by kneading. Examples of the binder include fluorocarbon resins, rubbers, acrylic polymers or vinyl polymers (homopolymers or copolymers of monomers such as acrylic monomers e.g. methyl acrylate and acrylonitrile, and vinyl monomers e.g. vinyl acetate). Examples of the fluorocarbon resins include polyvinylidene fluoride, copolymers of vinylidene fluoride and hexafluoropropylene, and polytetrafluoroethylene. Examples of the rubbers include acrylic rubber, modified acrylonitrile rubber, and styrene-butadiene rubber (SBR). The binder may be used singly or in combination of two or more. The binder may be used in the form of dispersion that is dispersed in a dispersing medium.

Examples of the usable conductive agent include carbon blacks such as acetylene black, ketjen black, channel black, furnace black, lump black, and thermal black; a variety of graphite such as natural graphite and artificial graphite; and conductive fiber such as carbon fiber and metal fiber.

A thickener may be used as necessary. Examples of the thickener include ethylene-vinyl alcohol copolymers and cellulose derivatives (carboxymethyl cellulose, methyl cellulose, etc.).

The dispersing medium is not particularly limited as long as it can dissolve or disperse the binder, and either organic solvents or water (including hot water) can be used according to the affinity of the binder with the dispersing medium. Examples of the organic solvents include N-methyl-2-pyrrolidone; ethers such as tetrahydrofuran; ketones such as acetone, methyl ethyl ketone, and cyclohexanone; amides such as N,N-dimethyl formamide and dimethyl acetamide; sulfoxides such as dimethyl sulfoxide; and tetramethyl urea. The dispersing medium may be used singly or in combination of two or more.

The positive electrode active material layer can be formed by preparing a material mixture in slurry state in which the positive electrode active material, and, as necessary, the binder, the conductive agent, and/or the thickener, are kneaded with the dispersing medium and dispersed, and then adhering this material mixture to the positive electrode current collector. Specifically, the positive electrode active material layer can be produced by applying the material mixture onto a surface of the positive electrode current collector by a known coating method, followed by drying and, as necessary, rolling. Formed on a part of the positive electrode current collector, is a portion where a surface of the current collector is exposed with no positive electrode active material layer thereon, and the positive lead is welded to this exposed portion. It is preferable that the positive electrode has good flexibility.

The application of the material mixture can be performed by using a known coater such as slit die coater, reverse roll coater, LIP coater, blade coater, knife coater, gravure coater, and dip coater. It is preferable that the drying after the application is performed under conditions close to air drying. However, in view of productivity, the drying may be performed in a temperature range of 70° C. to 200° C. for 10 minutes to 5 hours. The rolling of the active material layer can be performed, for example, by using a roll press machine and repeating the rolling a few times under the condition of a linear pressure of 1,000 to 2,000 kgf/cm (19.6 kN/cm) until a predetermined thickness is obtained. The rolling may be performed by changing the linear pressure as necessary.

At the time of kneading the material mixture in slurry state, a variety of dispersing agents, surfactants, stabilizers etc. may be added as necessary.

The positive electrode active material layer may be formed on one or both surfaces of the positive electrode current collector. When a lithium-containing transition metal compound is used as the active material, the active material density in the positive electrode active material layer is 3 to 4 g/ml, preferably 3.4 to 3.9 g/ml, 3.5 to 3.7 g/ml.

The thickness of the positive electrode is, for example, 70 to 250 μm, preferably 100 to 210 μm.

### Negative Electrode

The negative electrode includes a sheet-like negative electrode current collector and a negative electrode active material layer adhered to a surface of the negative electrode current collector. As the negative electrode current collector, a negative electrode current collector known for use in non-aqueous electrolyte secondary batteries, for example, metal foil made of copper, a copper alloy, nickel, a nickel alloy, stainless steel, aluminum, an aluminum alloy, etc. can be used. The negative electrode current collector is preferably copper foil, metal foil made of a copper alloy, etc. in view of processability, practical resistance, adhesiveness to the negative electrode active material layer, electronic conductivity, etc. The form of the current collector is not particularly limited and can be rolled foil, electrolytic foil, perforated foil, an expanded material, a lath material etc. The thickness of the negative electrode current collector is, for example, 1 to 100 μm, preferably 2 to 50 μm.

The negative electrode active material layer may include a conductive agent, a binder, a thickener, etc. in addition to the negative electrode active material. Examples of the negative electrode active material include materials having a graphitic-type crystal structure capable of reversibly absorbing and releasing lithium ions such as natural graphite, spherical or fibrous artificial graphite, non-graphitizable carbon (hard carbon), and graphitizable carbon (soft carbon). In particular, carbon materials having a graphitic-type crystal structure in which a spacing (d002) of a lattice plane (002) is 0.3350 to 0.3400 nm, are preferable. Further, silicon; silicon-containing compounds such as silicide; lithium alloys including at least one selected from tin, aluminum, zinc, and magnesium; and a variety of alloy materials, can be used.

Examples of the silicon-containing compounds include a silicon oxide SiO_{α} (0.05<α<1.95), where a is preferably 0.1 to 1.8, more preferably 0.15 to 1.6. In the silicon oxide, a part of silicon may be replaced by one or more elements. Examples of such elements include B, Mg, Ni, Co, Ca, Fe, Mn, Zn, C, N, and Sn.

As the binder, the conductive agent, the thickener, and the dispersing medium for use in the negative electrode, those indicated with regard to the positive electrode can be used.

The negative electrode active material layer can be formed, not only by the aforementioned coating in which the binder, etc. is used together, but also by a known method. For example, it may be formed by allowing the negative electrode active material to be deposited on the surface of the current collector by a gas phase method such as vacuum deposition method, sputtering method, ion plating method, etc. Alternatively, it can be formed by the same method as the positive electrode active material layer, by using a material mixture in slurry state including the negative electrode active material, the binder, and, as necessary, the conductive material.

The negative electrode active material layer may be formed on one or both surfaces of the negative electrode current collector. In the negative electrode active material layer formed by using an active material including carbon material as the active material, the active material density is 1.3 to 2 g/ml, preferably 1.4 to 1.9 g/ml, more preferably 1.5 to 1.8 g/ml.

The thickness of the negative electrode is, for example, 100 to 250 μm, preferably 110 to 210 μm. The negative electrode having flexibility is preferable.

### Separator

The thickness of the separator can be selected within a range of 5 to 35 μm, preferably 10 to 30 μm, or 12 to 20 μm. If the thickness of the separator is too small, minute short circuit is likely to occur in the battery. If the thickness of the separator is too large, the thicknesses of the positive electrode and the negative electrode are required to be reduced, and therefore the battery capacity may become insufficient.

The separator material is a polyolefin-based material, or a combination of a polyolefin-based material and a heat-resistant material. A polyolefin porous film that is widely used as a separator has a so-called shutdown function in which, when the battery temperature rises to a certain degree, micropores of the film are blocked by softening of polyolefin and loss of ion conductivity is caused, thereby stopping the battery reaction. However, if the battery temperature rises after the shutdown, there would be a meltdown where polyolefin melts, and as a result, short circuit is caused between the positive electrode and the negative electrode. Both the shutdown and the meltdown result from softening or melt properties of the resin that forms the separator. Therefore, in order to prevent effectively the meltdown while improving the shutdown function, a composite film of a combination of a polyolefin porous film and a heat-resistant porous film may be used as the separator.

Examples of the polyolefin porous film include porous films of polyethylene, polypropylene, and ethylene-propylene copolymers. These resins can be used singly or in combination of two or more. Other thermoplastic polymers may be combined with polyolefin as necessary.

The polyolefin porous film may be a porous film made of polyolefin, or woven or nonwoven cloth made of polyolefin fiber. The porous film is produced, for example, by forming a molten resin into a sheet, and then uniaxially or biaxially drawing the same. Also, the polyolefin porous film may be a single layer (porous film composed of one porous polyolefin layer) or may include two or more porous polyolefin layers.

As the heat-resistant porous film, a single film of a heat-resistant resin or an inorganic filler, or a mixture of a heat-resistant resin and an inorganic filler can be used.

Examples of the heat-resistant resin include polyarylate; aromatic polyamide (all aromatic polyamide etc.) such as aramid; polyimide resins such as polyimide, polyamide imide, polyether imide, and polyester imide; aromatic polyester such as polyethylene terephthalate; polyphenylene sulfide; polyether nitrile; polyether ether ketone; and polybenzimidazole. The heat-resistant resin may be used singly or in combination of two or more. In view of the retention of the non-aqueous electrolyte and the heat-resistance, aramid, polyimide, polyamide imide, etc. are preferable.

Specifically, examples of the heat-resistant resin include resins, etc. having heat deflection temperature of 260° C. or higher calculated under a load of 1.82 MPa in a measurement of deflection temperature under load in compliance with test method ASTM-D648 of American Society of Testing Materials. The upper limit of the heat deflection temperature is not particularly limited, but is about 400° C. in view of the separator characteristics and the heat decomposition properties of the resin. The higher the heat deflection temperature is, the easier the retention of the separator form is, even if the polyolefin porous film shrinks by heat. By using the resin having a heat deflection temperature of 260° C. or higher, sufficiently high heat stability can be exhibited even when the battery temperature rises (usually about 180° C.) due to heat accumulation at the time of overheat.

Examples of the inorganic filler include metal oxides such as iron oxide; ceramics such as silica, alumina, titania, and zeolite; mineral-based fillers such as talc and mica; carbon-based fillers such as activated carbon and carbon fiber; carbides such as silicon carbide; nitrides such as silicon nitride and; glass fiber, glass beads, and glass flakes. The form of the inorganic filler is not particularly limited and may be particle form, powder form, fiber form, flake form, lump form, etc. The inorganic filler may be used singly or in combination of two or more.

When the heat-resistant resin and the inorganic filler are included in the heat-resistant porous film, the proportion of the inorganic filler is, for example, 50 to 400 parts by weight, preferably 80 to 300 parts by weight, relative to 100 parts by weight of the heat-resistant resin. The more the inorganic filler is included, the higher the hardness and the coefficient of friction of the heat-resistant porous film are, and the lower the slipperiness of the surface thereof is.

The thickness of the heat-resistant porous film is 1 to 16 μm, preferably 2 to 10 μm in view of balance between the safety against internal short circuit and the electric capacity. If the thickness is too small, the effect of suppressing heat shrinkage of the polyolefin porous film in a high-temperature environment becomes lower. Since the heat-resistant porous film has relatively a low porosity and a low ion-conductivity, the impedance increases and the charge and discharge characteristics become lower if the thickness is too large.

In the case of the composite film of the polyolefin porous film and the heat-resistant porous film, the thickness of the polyolefin porous film is preferably 2 to 17 μm, preferably 3 to 10 μm, in view of removal of the winding cores and of shutdown characteristics. Since the heat-resistant porous film is harder than the polyolefin porous film, the heat-resistant porous film has preferably a smaller thickness than the polyolefin porous film. However, if the thickness of the polyolefin porous film is too large, the polyolefin porous film shrinks greatly and the heat-resistant porous layer is likely to be pulled when the battery has a high temperature. The thickness of the polyolefin porous film is, for example, 1.5 to 8 times, preferably 2 to 7 times, more preferably 3 to 6 times, the thickness of the heat-resistant porous film.

The porosity in the polyolefin porous film is, for example, 20 to 80%, preferably 30 to 70%. Also, the average pore diameter in the polyolefin porous film can be selected within a range of 0.01 to 10 μm, preferably 0.05 to 5 μm, in view of the ion conductivity and the mechanical strength. The porosity of the heat-resistant porous film is, for example, 20 to 70%, preferably 25 to 65%, in view of ensuring sufficiently the mobility of lithium ions.

The separator may include a conventional additive (antioxidant etc.). The additive may be included in any of the heat-resistant porous film and the polyolefin porous film. Examples of such an antioxidant include at least one selected from the group consisting of a phenol-based antioxidant, a phosphoric acid-based antioxidant, and a sulfur-based antioxidant. The phenol-based antioxidant, the phosphoric acid-based antioxidant, and the sulfur-based antioxidant may be combined. The sulfur-based antioxidant has a high compatibility with polyolefin. Therefore, it is preferably included in the polyolefin porous film (polypropylene porous film, etc.).

Examples of the phenol-based antioxidant include hindered phenol compounds such as 2,6-di-t-butyl-p-cresol, 2,6-di-t-butyl-4-ethylphenol, triethylene glycol-bis[3-(3-t-butyl-5-methyl-4-hydroxyphenyl)propionate], and n-octadecyl-3-(3,5-di-t-butyl-4-hydroxyphenyl)propionate. Examples of the sulfur-based antioxidant include dilauryl thiodipropionate, distearyl thiodipropionate, and dimyristyl thiodipropionate. As the phosphoric acid-based antioxidant, tris(2,4-di-t-butylphenyl)phosphate, etc. are preferable.

### Non-Aqueous Electrolyte

The non-aqueous electrolyte is prepared by dissolving a lithium salt in a non-aqueous solvent. Examples of the non-aqueous solvent include cyclic carbonates such as ethylene carbonate, propylene carbonate, and butylene carbonate; chain carbonates such as dimethyl carbonate and diethyl carbonate; lactones such as γ-butylolactone; halogenated alkanes such as 1,2-dichloroethane; alkoxy alkanes such as 1,2-dimethoxyethane and 1,3-dimethoxypropane; ketones such as 4-methyl-2-pentanone; ethers such as 1,4-dioxane, tetrahydrofuran, and 2-metyl tetrahydrofuran; nitriles such as acetonitrile, propionitrile, butylonitrile, valeronitrile, and benzonitrile; sulfolane and 3-methyl-sulfolane; amides such as dimethyl formamide; sulfoxide such as dimethyl sulfoxide; and alkyl ester phosphates such as trimethyl phosphate and triethyl phosphate. The non-aqueous solvent may be used singly or in combination of two or more.

Examples of the lithium salt include highly electron-withdrawing lithium salts such as LiPF₆, LiBF₄, LiClO₄, LiAsF₆, LiCF₃SO₃, LiN(SO₂CF₃)₂, LiN(SO₂C₂F₅)₂, and LiC(SO₂CF₃)₃. The lithium salt may be used singly or in combination of two or more. The concentration of the lithium salt in the non-aqueous electrolyte is, for example, 0.5 to 1.5 M, preferably 0.7 to 1.2 M.

The non-aqueous electrolyte may include additives, as appropriate. For example, in order to form a favorable coating film on a surface of the positive electrode or the negative electrode, vinylene carbonate (VC), cyclohexylbenzene (CHB), and modified products thereof, etc. may be used. As additives that act when the lithium ion secondary battery is in an overcharged state, terphenyl, cyclohexylbenzene, diphenyl ether etc. may be used, for example. The additives may be used singly or in combination of two or more. The proportion of such additives is not particularly limited and is, for example, about 0.05 to 10 wt % relative to the non-aqueous electrolyte.

Examples of the battery case include a cylindrical case and a prismatic case having an open upper end. The material for the case is preferably an aluminum alloy including a very small amount of metal such as manganese or copper; an inexpensive steel plate plated with nickel; or the like, in view of pressure resistance.

The present invention will be described by referring to Examples. It is to be noted that the content described herein is only an example of the present invention and the present invention is not limited to the Examples.

### EXAMPLE 1

### (1) Production of Positive Electrode (First Electrode)

To an appropriate amount of N-methyl-2-pyrrolidone, 100 parts by weight of lithium cobaltate as a positive electrode active material, 2 parts by weight of acetylene black as a conductive agent, and 3 parts by weight of polyvinylidene fluoride resin as a binder were added and kneaded, thereby preparing a material mixture in slurry state. This slurry was applied onto both surfaces of strip-like aluminum foil (thickness: 15 μm) having a length of a plurality of positive electrodes. The application was performed intermittently, that is, part-by-part corresponding to one-by-one of the positive electrodes. This was followed by drying. Next, rolling was performed two or three times at a linear pressure of 1,000 kgf/cm (9.8 kN/cm), thereby adjusting the thickness to 180 μm. A positive electrode having a size of a width of 57 mm and a length of 620 mm was cut out from the obtained positive electrode continuum, thereby obtaining a positive electrode 5. At this time, an end portion 5a on the winding-end side was cut into a zigzag structure as shown in FIG. 3. An end portion on the winding-start side was made into a linear form. The active material density of the positive electrode active material layer was 3.6 g/ml.

A wave height B was set to 10 mm and a wavelength λ was set to 10 mm. At this time, the angle corresponding to an angle α formed by a line segment PQ and a line segment QR in FIG. 3 was about 53.2°.

A positive lead terminal 5b made of aluminum was ultrasonic welded to an exposed portion of the aluminum foil without the positive electrode active material layer thereon. An insulating tape made of a polypropylene resin was adhered to the ultrasonic welded portion so as to cover the positive lead terminal 5b.

### (2) Production of Negative Electrode (Second Electrode)

To an appropriate amount of water, 100 parts by weight of scaly graphite capable of absorbing and releasing lithium as a negative electrode active material, 1 part by weight in solid weight of an aqueous dispersion of styrene-butadiene rubber (SBR) as a binder, and 1 part by weight of sodium carboxymethyl cellulose as a thickener were added and kneaded, thereby preparing a material mixture in slurry state. This slurry was applied onto both surfaces of strip-like copper foil (thickness: 10 μm) having a length of a plurality of negative electrodes. This application was performed intermittently, that is, part-by-part corresponding to one-by-one of the negative electrodes. This was followed by drying at 110° C. for 30 minutes. Next, rolling was performed two or three times at a linear pressure of 110 kgf/cm (1.08 kN/cm), thereby adjusting the thickness to 174 μm. A negative electrode having a size of a width of 59 mm and a length of 645 mm was cut out from the obtained negative electrode continuum, thereby producing a negative electrode 6. At this time, end portions on both the winding-start side and the winding-end side were made into a linear form. The active material density of the negative electrode active material layer was 1.6 g/ml.

A negative lead terminal 6b made of nickel was resistance welded to an exposed portion of the copper foil without the negative electrode active material layer thereon. An insulating tape made of a polypropylene resin was adhered to the resistance welded portion so as to cover the negative lead terminal 6b.

### (3) Production of Separator

A composite film of a polyethylene porous film and a heat-resistant porous film made of aramid was produced. Specifically, an N-methyl-2-pyrrolidone (NMP) solution of aramid including calcium chloride was applied onto one surface of a polyethylene porous film (thickness: 16.5 μm) in such a ratio that the separator thickness would be 20 μm, and then dried. Further, the obtained laminate was washed with water to remove the calcium chloride therefrom, thereby forming micropores in the layer including aramid. This layer was then dried to produce a heat-resistant porous film. The obtained separator 7 was cut into a size of a width of 60.9 mm and a length that was sufficiently longer than the positive electrode and the negative electrode.

The NMP solution of aramid was prepared in the following manner.

First, a predetermined amount of dry anhydrous calcium chloride was added to an appropriate amount of NMP and heated to be dissolved completely in a reaction vessel. After this NMP solution of calcium chloride was brought back to room temperature, a predetermined amount of paraphenylene diamine (PPD) was added thereto and was dissolved completely. Next, dichloroterephthalate (TPC) was instilled little by little in the solution, thereby synthesizing polyparaphenylene terephthalamide (PPTA) by polymerization reaction. After the end of reaction, stirring was performed under reduced pressure for 30 minutes for degassing. The obtained polymeric solution was diluted appropriately with the NMP solution of calcium chloride, thereby preparing an NMP solution of aramid resin.

### (4) Production of Electrode Group

The positive electrode 5 and the negative electrode 6 were wound spirally with the separator 7 disposed therebetween to form an electrode group 14. Specifically, the positive electrode 5, the separator 7, the negative electrode 6, and the other separator 7 were stacked in this order in the state where the end portions in the lengthwise direction of the two separators protruded from the positive electrode 5 and the negative electrode 6. The protruded end portions of the two separators were sandwiched by a pair of winding cores, and the laminate was wound around the winding cores as the winding axis, thereby forming an electrode group 14 in spiral form. At this time, the negative electrode was placed on an outer circumferential side being further outward than the end portion in non-linear form of the positive electrode, and the negative electrode was made to face the end portion in non-linear form. After the winding, the separators were cut and released from the winding cores, and the winding cores were removed from the electrode group.

In the electrode group, the length of each separator was 700 to 720 mm.

### (5) Production of Non-Aqueous Electrolyte Secondary Battery

By using the electrode group 14, a cylindrical lithium ion secondary battery as illustrated in FIG. 9 was produced.

First, the electrode group 14 and a lower insulating plate 9 were housed in a battery case 1 (diameter: 17.8 mm, total height: 64.8 mm) made of metal produced by press-molding from a nickel-plated steel plate (thickness: 0.20 mm). At this time, the lower insulating plate 9 was sandwiched between the bottom surface of the electrode group 14 and the negative lead terminal 6b led out to the lower side from the electrode group 14. The negative lead terminal 6b was resistance welded to the inner bottom surface of the battery case 1.

An upper insulating ring was mounted on an upper surface of the electrode group 14 housed in the battery case 1. An annular step portion was formed over the upper insulating ring and on the upper side surface of the battery case 1, and the electrode group 14 was fixed in the case 1. The positive lead terminal 5b led out to the upper side of the battery case 1 was laser welded to a sealing plate 2. Next, the non-aqueous electrolyte was injected into the battery case 1.

The non-aqueous electrolyte was prepared by dissolving LiPF₆ in a mixed solvent of ethylene carbonate (EC) and ethyl methyl carbonate (EMC) (volume ratio: 2:1) so as to have a concentration of 1.0 M, and adding thereto 0.5 wt % of cyclohexylbenzene.

Next, the positive lead terminal 5b was bent and housed in the battery case 1, and the sealing plate 2 provided with a gasket 13 on the periphery thereof was mounted over the annular step portion. Then, the opening end portion of the battery case 1 was caulked inward and sealed, thereby completing the battery. This battery was of 18,650 type having a diameter of 18.1 mm and a height of 65.0 mm, and a nominal capacity of 2,800 mAh. Three hundred of the same cylindrical lithium ion secondary batteries were produced.

### EXAMPLE 2

Three hundred non-aqueous electrolyte secondary batteries were produced in the same manner as in Example 1 except for cutting the end portion 5a of the positive electrode 5 into the form as shown in FIG. 4.

The angle corresponding to an angle θ formed between a linear portion L and an oblique line portion M was set to 45°.

The wave height B was set to 10 mm and the wavelength λ was set to 10 mm.

### EXAMPLE 3

Three hundred non-aqueous electrolyte secondary batteries were produced in the same manner as in Example 1 except for cutting the end portion 5a of the positive electrode 5 into the form as shown in FIG. 5.

The wave height B was set to 10 mm and the wavelength λ was set to 20 mm.

### COMPARATIVE EXAMPLE 1

Three hundred non-aqueous electrolyte secondary batteries were produced in the same manner as in Example 1 except for cutting the end portion of the positive electrode 5 into the conventional linear form.

The charge and discharge characteristics of the batteries of the Examples and the Comparative Example were evaluated.

The charge and discharge tests were performed in a thermostatic bath at 45° at a charge rate corresponding to 0.8 C and a discharge rate corresponding to 1 C. The discharge capacity was measured for every cycle and the measurements were performed up to 500 cycles. The capacity retention rate of the discharge capacity of the battery after 500 cycles, relative to the initial discharge capacity, was calculated. Then, the average value of the capacity retention rates of the 300 batteries was determined. The results are shown in Table 1.

TABLE 1

| | | Capacity retention | Occurrence rate of |
|---|---|---|---|
| | Form of end | rate at 500^{th} cycle | sharp capacity drop |
| | portion | (%) | (%) |
| Ex. 1 | FIG. 3 | 83.2 | 0 |
| Ex. 2 | FIG. 4 | 85.6 | 0 |
| Ex. 3 | FIG. 5 | 87.4 | 0 |
| Co. Ex. 1 | linear | 65.2 | 13 (39/300) |

In Examples 1 to 3, a sharp capacity drop did not occur during the charge and discharge cycles, and no rupture of the electrodes was found when the batteries were decomposed and observed after 500 cycles.

In contrast, in Comparative Example 1, 39 of the 300 batteries caused a sharp capacity drop before reaching 200 cycles. The capacity retention rate of Comparative Example 1 was an average value of 261 batteries. The batteries that caused a sharp capacity drop were decomposed and the electrodes were observed, and it was found that, in all the batteries, the negative electrode on the outermost circumference was ruptured completely at the portion facing the end portion of the positive electrode on the inner side. Further, 10 batteries of Comparative Example 1 that did not cause a sharp capacity drop before reaching 500 cycles, were selected arbitrary and decomposed. Then the electrodes were observed and a partial rupture, but not a complete rupture, was found in all the batteries.

These results demonstrate that the stress toward the negative electrode on the outermost circumference during the charge and discharge cycle was dispersed or eased, by making the end portion of the positive electrode into the non-linear form. Consequently, it is considered that the rupture of the negative electrode on the outermost circumference was suppressed. There are still differences among the capacity retention rates of Examples 1 to 3, and this is considered to be due to the form of the end portion of the positive electrode. Although no rupture of the negative electrode was found when the batteries of the Examples were decomposed and observed as described above, it is considered that a subtle difference was produced among the batteries in terms of metal fatigue of the current collector that was not visually discernible.

In the above Examples, the non-linear form of the end portion of the positive electrode was a form in which the same form continued periodically, or was a point-symmetric form, but it is not limited thereto. For example, it may be a combination of different forms, or an asymmetrical form. Further, in the electrode groups in the Examples, the negative electrode was placed on the outermost circumference, but the same effect can be obtained even when the positive electrode is placed on the outermost circumference.

### INDUSTRIAL APPLICABILITY

The present invention is effective for use in a non-aqueous electrolyte secondary battery comprising an electrode group in which a long positive electrode, a long negative electrode, and a long separator disposed therebetween are wound spirally. The present invention is particularly effective in a non-aqueous electrolyte secondary battery with a high capacity, using the positive electrode or the negative electrode in which a large amount of active material is filled.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: Battery case
2: Sealing plate
5: First electrode (positive electrode)
5A: First electrode continuum
5a: End portion
5b: Positive lead terminal
6: Second electrode (negative electrode)
6A: Second electrode continuum
6b: Negative lead terminal
7: Separator
7A: Separator continuum
9: Lower insulating plate
12: Positive external terminal
13: Gasket
14: Electrode group
70: Winding core
71: First electrode rolling-out roller
72: Second electrode rolling-out roller
73, 74: Separator continuum rolling-out rollers
75: Tension roller
76: Control roller
90: Lithium ion secondary battery

1. A non-aqueous electrolyte secondary battery comprising: an electrode group in which a long first electrode, a long second electrode, and a long separator disposed therebetween are wound spirally; and a non-aqueous electrolyte,
wherein the first electrode includes a sheet-like first current collector and a first active material layer disposed on a surface of the first current collector,
the second electrode includes a sheet-like second current collector and a second active material layer disposed on a surface of the second current collector, and
an end portion of the first electrode on a winding-end side of the electrode group has a non-linear form and faces the second electrode with the separator therebetween, the second electrode being placed on an outer circumferential side that is further outward than the end portion.

2. The non-aqueous electrolyte secondary battery in accordance with claim 1, wherein the non-linear form includes polygonal lines or curves in a continuous pattern.

3. The non-aqueous electrolyte secondary battery in accordance with claim 1, wherein the non-linear form includes a waveform.

4. The non-aqueous electrolyte secondary battery in accordance with claim 3, wherein the waveform is a triangle wave, a saw tooth wave, a sine wave, a trapezoidal wave, a square wave, or arcs in a continuous pattern, the arcs being connected at both ends such that they are alternately in opposite directions.

5. The non-aqueous electrolyte secondary battery in accordance with any of claims 1 to claim 1, wherein the non-linear form is a point-symmetric form with respect to a center thereof.

6. A method of producing a non-aqueous electrolyte secondary battery comprising the steps of:
preparing a first electrode continuum in which a plurality of long first electrodes ranges in a lengthwise direction;
cutting out one of the long first electrodes from the first electrode continuum, the one first electrode having one end portion in the lengthwise direction thereof in non-linear form;
preparing a long second electrode;
preparing a long separator; and
winding spirally the one first electrode, the second electrode, and the separator disposed therebetween such that the end portion in non-linear form of the one first electrode is an end portion on a winding-end side and that the second electrode is placed on an outer circumferential side being further outward than the end portion and faces the end portion with the separator therebetween.

7. A method of producing a non-aqueous electrolyte secondary battery comprising the steps of:
providing a first electrode continuum in which a plurality of long first electrodes ranges in a lengthwise direction;
providing a second electrode continuum in which a plurality of long second electrodes ranges in a lengthwise direction;
providing a separator continuum having a length of a plurality of long separators;
winding spirally the first electrode continuum, the second electrode continuum, and the separator continuum disposed therebetween, from a winding-start position to a winding-end position, that are respectively corresponding to an n^{th} first electrode, an n^{th} second electrode, and an n^{th} separator;
cutting the first electrode continuum at the winding-end position of the n^{th} first electrode such that an end portion in non-linear form is produced on the n^{th} first electrode and an (n+1)^{th} first electrode; and
cutting each of the separator continuum and the second electrode continuum at the winding-end position, such that the n^{th} second electrode is placed on an outer circumferential side being further outward than the end portion in non-linear form and that the n^{th} second electrode faces the end portion in non-linear form with the n^{th} separator therebetween.

8. The method of producing the non-aqueous electrolyte secondary battery in accordance with claim 7, further comprising the steps of:
cutting out the (n+1)^{th} first electrode from the first electrode continuum such that an end portion in linear form is produced on the (n+1)^{th} first electrode and an (n+2)^{th} first electrode;
winding spirally the (n+1)^{th} first electrode and the second electrode continuum from a winding-start position to a winding-end position corresponding to the (n+1)^{th} second electrode, with the separator continuum from a winding-start position to a winding-end position corresponding to an (n+1)^{th} separator therebetween, such that the end portion in non-linear form of the (n+1)^{th} first electrode is an end portion on the winding-end side; and
cutting each of the separator continuum and the second electrode continuum at the winding-end position, such that the (n+1)^{th} second electrode is placed on an outer circumferential side being further outward than the end portion in non-linear form and that the (n+1)^{th} second electrode faces the end portion in non-linear form with the (n+1)^{th} separator therebetween.
